(19) United States
(12) Patent Application Publication
(10) Pub. No.: US 2007/0214286 A1
(43) Pub. Date: Sep. 13, 2007

(54) NETWORK ACCESS CONTROL

(75) Inventors: Alaaa Hilal Muqattash, San Diego, CA (US); Ghobad Heidari-Bateni, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(73) Assignee: Olympus Communication Technology of America, Inc.

(21) Appl. No.: 11/558,239

(22) Filed: Nov. 9, 2006

Related U.S. Application Data
(60) Provisional application No. 60/735,936, filed on Nov. 10, 2005.

(51) Int. Cl. G06F 15/16

(52) U.S. Cl. 709/248

(57) ABSTRACT

A communications protocol is configured to determine whether multiple simultaneous communications can take place among a plurality of network devices in a wireless network. In one embodiment, a first network device can determine the maximum interference in can sustain while still conducting intended communications with another network device. The first network device can also compute additional maximum sustainable interference it can tolerate based on current interference levels. The first network device can be configured to communicate its additional maximum sustainable interference to a third network device that wishes to conduct communications in the same time frame. The third network device can be configured to compute its maximum allowable power based on the first device's additional maximum sustainable interference and to further determine the minimum transmit power required to conduct its transmit operation. If the minimum transmit power will cause an amount of interference to the first device greater than its additional maximum sustainable interference, then the communication is rescheduled.

### RELATED APPLICATION(S)

This application claims benefit of U.S. Provisional application Ser. No. 60/735,936 filed Nov. 10, 2005, which is hereby incorporated herein by reference in its entirety.

### TECHNICAL FIELD

The present invention relates to network communications, and more particularly, some embodiments relate to mesh network communications.

### DESCRIPTION OF THE RELATED ART

A mesh network (also known as a multi-hop network) is a collection of autonomous devices connected by links, where each device in the network can be configured to operate as a client as well as a router. Devices transmit at a power signal capable of reaching one or more neighboring devices. A recipient neighboring device can, in turn, transmit the signal to another device in its range. This process can be repeated from device to device until the data arrives at its destination. Thus, mesh networks allow for connections by hopping from node to node until the destination is reached. Range extension and robustness can thus be achieved with mesh networks.

Where multiple alternative paths are available, some mesh networks allow for reconfiguration around broken or blocked paths. Such mesh networks are referred to as self-healing, as the network can still operate even when a node or a connection is out of service. As such, mesh networks can be a very reliable or resilient type of network.

One disadvantage that might be associated with mesh networks is the restriction placed on simultaneous communications. For example, conventional WiMedia MAC protocol does not allow concurrent access to the medium within a neighborhood. Indeed the current WiMedia MAC protocol can be overly conservative, leading to an unnecessary reduction in network throughput. The inability of one device to transmit to its recipient while another device is transmitting to its own recipient is the well-known exposed device problem. To enable data forwarding or routing, protocols for auto-configuring paths between devices must be developed. Routing protocols for mesh networks should be designed to leverage some of the information available freely by the MAC protocol (e.g., neighborhood) and information available by the PHY (i.e., link quality).

### BRIEF SUMMARY OF EMBODIMENTS OF THE INVENTION

According to various embodiments of the invention systems and methods for allocating communication bandwidth in a network are provided. In one embodiment, a method of allocating simultaneous communications among a plurality of network devices, comprises the steps of determining a maximum power level that a first device can use in transmitting information to a second device during a given time period without causing a predetermined level of interference to a third device; determining a minimum amount of power required for the first device to effectively transmit information to the second device; and determining whether the minimum power required is less than the maximum power level, and if so, allowing the first device to transmit information to the second device during the given time period. The method can further be implemented to perform the step of prohibiting the first device from transmitting information to the second device during the given time period if the minimum power required is more than the maximum power level.

In one embodiment, the invention can be implemented such that the step of determining a maximum power level, comprises the steps of determining a maximum interference a third device can sustain and determining a power level for the first device that would invoke the maximum interference on the third device. Additionally, the invention can be implemented such that the steps of determining are all performed by the first network device to determine whether it can transmit data during the given time period.

In one embodiment, the maximum allowable power is computed as P_{MAP}=P_{MSI}/G, where P_{MAP} is the maximum allowable power of the first device, P_{MSI} is the interference caused to the third device, and G is the channel gain between the first device and the third device.

The method can be implemented to further include the steps of the third device computing its maximum acceptable interference level for the given time period, and the third device transmitting a value representing the maximum acceptable interference level for the given time period to the first device. The method can also be implemented such that the maximum acceptable interference level comprises the maximum additional interference that the third device can sustain from new transmissions in its vicinity.

In another embodiment of the invention, a network device is configured to determine whether it can conduct simultaneous communications with another network device in a given time slot. The network device can be configured to include first control logic configured to determine a maximum power level that a first device can use in transmitting information to a second device during a given time period without causing a predetermined level of interference to a third device; second control logic configured to determine a minimum amount of power required for the first device to effectively transmit information to the second device; and third control logic configured to determine whether the minimum power required is less than the maximum power level, and if so, allowing the first device to transmit information to the second device during the given time period.

In a further embodiment, the third control logic is configured to prohibit the first device from transmitting information to the second device during the given time period if the minimum power required is more than the maximum power level. In still a further embodiment, the first control logic is configured to determine a maximum interference a third device can sustain and determining a power level for the first device that would invoke the maximum interference on the third device. In yet a further embodiment, the device is configured to include fourth control logic configured to compute the maximum acceptable interference level the network device can sustain for a given time period. Additionally, in one embodiment, the maximum acceptable interference level comprises the maximum additional interference that the third device can sustain from new transmissions in its vicinity. The device can be implemented such that the maximum allowable power is computed as P_{MAP}=P_{MSI}/G, where P_{MAP} is the maximum allowable power of the first device, P_{MSI} is the interference caused to the third device, and G is the channel gain between the first device and the third device.

Yet another embodiment of the invention provides a computer program product comprising a computer useable medium having computer program logic embodied therein for enabling a controller in a network device to determine whether the network device can transmit data to a second network device in a given time period, wherein the computer program logic includes first computer readable program code for enabling the controller to determine a maximum power level that a first device can use in transmitting information to a second device during a given time period without causing a predetermined level of interference to a third device; second computer readable program code for enabling the controller to determine a minimum amount of power required for the first device to effectively transmit information to the second device; and third computer readable program code for enabling the controller to determine whether the minimum power required is less than the maximum power level, and if so, allowing the first device to transmit information to the second device during the given time period.

In one implementation, the third computer readable program code causes the controller to prohibit the first device from transmitting information to the second device during the given time period if the minimum power required is more than the maximum power level. In another implementation, the first computer readable program code causes the controller to determine a maximum interference a third device can sustain and determining a power level for the first device that would invoke the maximum interference on the third device. Additionally, fourth computer readable program code can be included to enable the controller to compute the maximum acceptable interference level the network device can sustain for a given time period. In one embodiment, the maximum acceptable interference level comprises the maximum additional interference that the third device can sustain from new transmissions in its vicinity. In another embodiment, the maximum allowable power is computed as P_{MAP}=P_{MSI}/G, where P_{MAP} is the maximum allowable power of the first device, P_{MSI} is the interference caused to the third device, and G is the channel gain between the first device and the third device.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a block diagram illustrating one possible configuration of a wireless network that can serve as an example environment in which the present invention can be implemented.

FIG. 2 is a diagram illustrating an example of a mesh network as one possible implementation of the example wireless network illustrated in FIG. 1.

FIG. 3 is a diagram illustrating time slots that can be implemented with a wireless network.

FIG. 4 is a diagram illustrating an example of six network devices spatially oriented in one dimension relative to one another.

FIG. 5 is a diagram illustrating another example of network devices spatially oriented in one dimension relative to one another.

FIG. 6 is an operational flow diagram illustrating an example communication exchange with reference to the example configuration illustrated in FIG. 5 in accordance with one embodiment of the invention.

FIG. 7 is a diagram illustrating an example process for determining whether network devices can communicate during the same time period in accordance with one embodiment of the invention.

FIG. 8 is a diagram illustrating an example network configuration.

FIG. 9 is a diagram illustrating a protocol wherein a device is configured to send a block ACK at the end of the period.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Before describing the invention in detail, it is useful to describe an example environment in which the invention can be implemented. One such example is a wireless network in which multiple electronic devices (for example, computers and computing devices, cellular telephones, personal digital assistants, motion and still cameras, among others) can communicate and share data, content and other information with one another. One example of such a network is that specified by the WiMedia standard (within WiMedia and Multi-Band OFDM Alliance). From time-to-time, the present invention is described herein in terms of a distributed network or in terms of a WiMedia standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a distributed wireless network, nor is it limited to a WiMedia standard described as one implementation of the example environment.

Most network standards specify policies or rules that govern the behavior of network connected devices. The WiMedia standard specifies the mechanism and policies that are to be followed by W-USB and WiNet compliant devices in order to allow for an ad hoc and distributed network of such devices to operate efficiently.

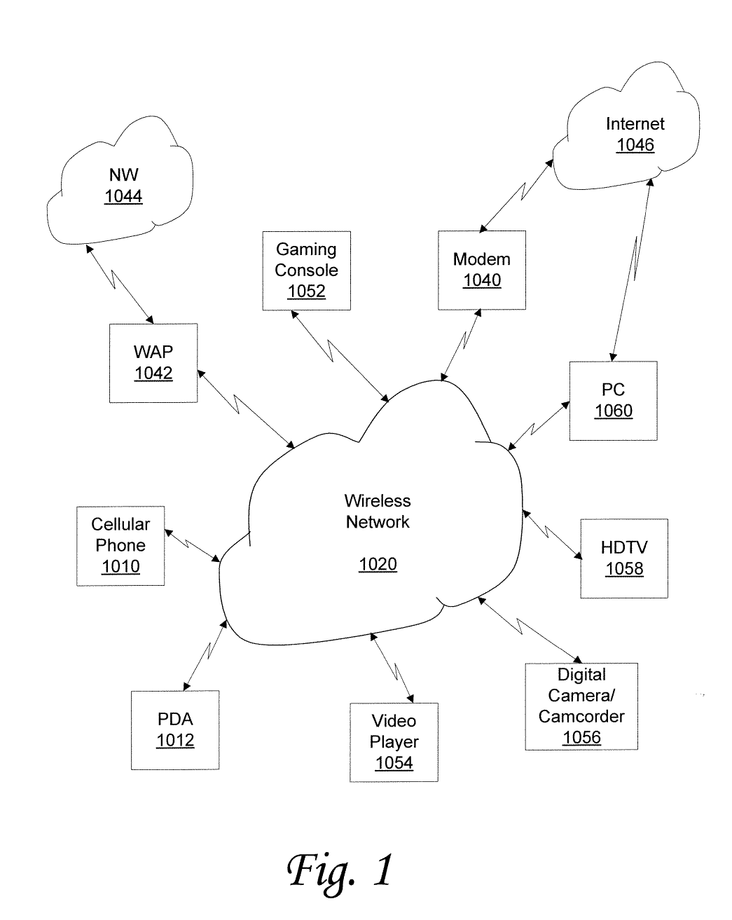

FIG. 1 is a block diagram illustrating one possible configuration of a wireless network that can serve as an example environment in which the present invention can be implemented. Referring now to FIG. 1, a wireless network 1020 is provided to allow a plurality of electronic devices to communicate with one another without the need for wires or cables between the devices. A wireless network 1020 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 1020 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 1020 includes a communication device to allow it to communicate with external networks. More particularly, in the illustrated example, wireless network 1020 includes a modem 1040 to provide connectivity to an external network such as the Internet 1046, and a wireless access point 1042 that can provide external connectivity to another network 1044.

Also illustrated in the example wireless network 1020 are portable electronic devices such as a cellular telephone 1010 and a personal digital assistant (PDA) 1012. Like the other electronic devices illustrated in FIG. 1, cellular telephone 1010 and PDA 1012 can communicate with wireless network 1020 via the appropriate wireless interface. Additionally, these devices may be configured to further communicate with an external network. For example, cellular telephone 1010 is typically configured to communicate with a wide area wireless network by way of a base station.

Additionally, the example environment illustrated in FIG. 1 also includes examples of home entertainment devices connected to wireless network 1020. In the illustrated example, electronic devices such as a gaming console 1052, a video player 1054, a digital camera/camcorder 1056, and a high definition television 1058 are illustrated as being interconnected via wireless network 1020. For example, a digital camera or camcorder 1056 can be utilized by a user to capture one or more still picture or motion video images. The captured images can be stored in a local memory or storage device associated with digital camera or camcorder 1056 and ultimately communicated to another electronic device via wireless network 1020. For example, the user may wish to provide a digital video stream to a high definition television set 1058 associated with wireless network 1020. As another example, the user may wish to upload one or more images from digital camera 1056 to his or her personal computer 1060 or to the Internet 1046. This can be accomplished by wireless network 1020. Of course, wireless network 1020 can be utilized to provide data, content, and other information sharing on a peer-to-peer or other basis, as the provided examples serve to illustrate.

Also illustrated is a personal computer 1060 or other computing device connected to wireless network 1020 via a wireless air interface. As depicted in the illustrated example, personal computer 1060 can also provide connectivity to an external network such as the Internet 1046.

In the illustrated example, wireless network 1020 is implemented so as to provide wireless connectivity to the various electronic devices associated therewith. Wireless network 1020 allows these devices to share data, content, and other information with one another across wireless network 1020. Typically, in such an environment, the electronic devices would have the appropriate transmitter, receiver, or transceiver to allow communication via the air interface with other devices associated with wireless network 1020. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 1020 are sometimes referred to herein as network devices, members or member devices of the network or devices associated with the network. In one embodiment devices that communicate with a given network may be members or merely in communication with the network.

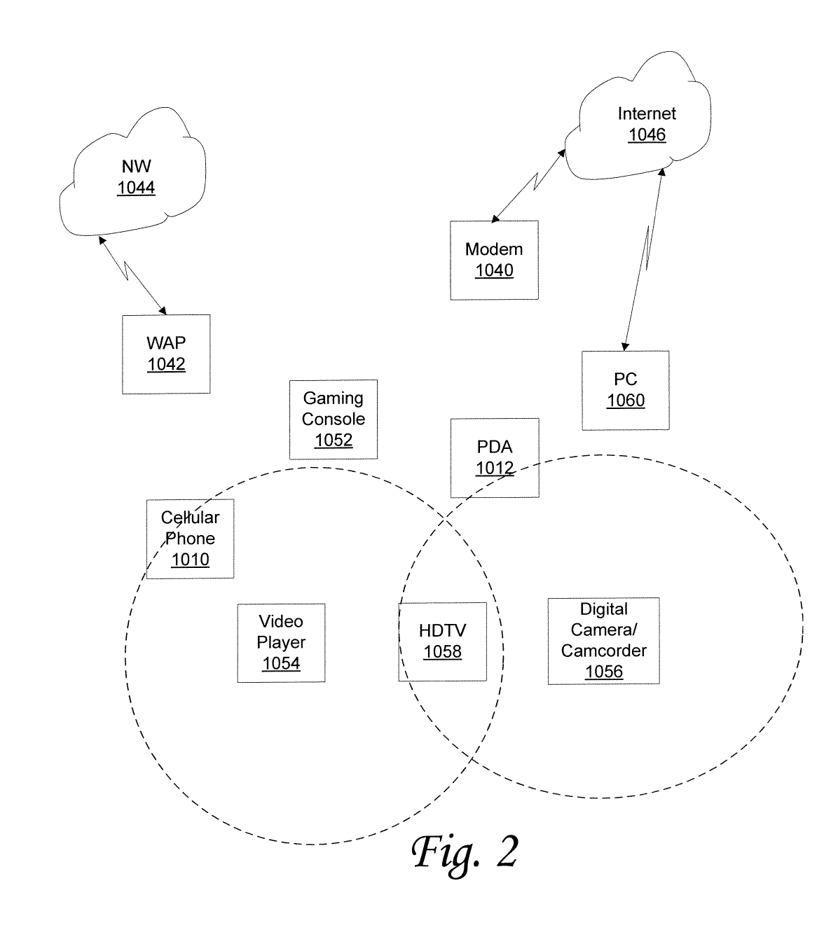

FIG. 2 is a diagram illustrating an example implementation of the wireless network 1020 illustrated in FIG. 1. Referring now to FIG. 2, this example implementation is a mesh network, wherein network devices communicate with neighboring devices within their range. If a device wishes to communicate to another network device out of range, it may use an in-range neighboring device to relay or route the communication to the recipient. Depending on the respective locations of communicating devices, one or more intermediary recipients may be included. Although signal paths are not illustrated within the wireless network 1020 of FIG. 2, dashed line circles are provided to illustrate an example of communication radii that might be associated with two sample network devices. In the illustrated example, assume that digital camcorder 1056 wants to send a digital video to video player 1054 for storage and later playback via HDTV 1058. As the example radius illustrates, camcorder 1056 cannot reach video player 1054 directly. However, in this example, HDTV 1058 is in range of both devices. Therefore, HDTV 1058 is used as an intermediary to route the digital video from camcorder 1056 to video player 1054.

Some communication networks are divided into periods or frames that can be used for communication and other activities. For example, as discussed above, some networks have a scheduling window such as, for example, a beacon period, for scheduling upcoming communication activities. Also, some networks have a communication window during which such communication activities take place. In the WiMedia-MBOA standard, the bandwidth is divided into superframes, which in turn are divided into time slots for the transmission and reception of data by the various electronic devices associated with the network.

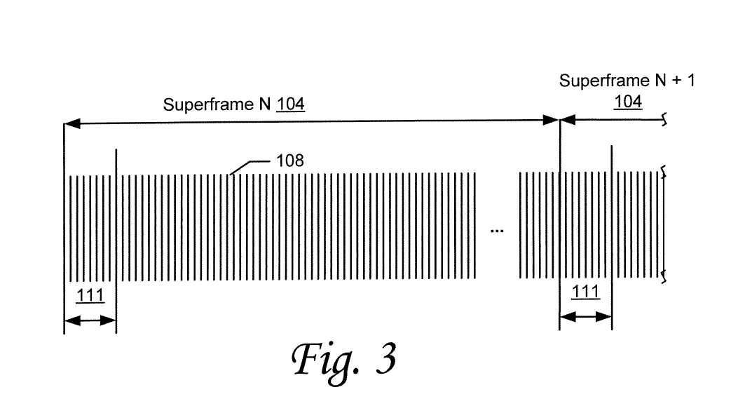

An example of such time slots is illustrated in FIG. 3. Referring now to FIG. 3, in this exemplary environment, the communication bandwidth is divided into superframes 104 (two illustrated), each superframe 104 itself being divided into a plurality of time slots referred to as Media Access Slots 108. In the example environment, there are 256 media access slots 108 in each superframe 104, although other allocations are possible. Additionally, at the beginning of each superframe 104 is a beacon period 111, which is comprised of a plurality of beaconing slots. In some networks, the beacon period 111 is a period during which devices reserve timeslots and exchange other housekeeping or status information. For example, in the WiMedia-MBOA distributed wireless network, the superframes comprise a beacon period 111, during which devices are awake and receive beacons from other devices. Superframes in the above-referenced standard, and other time periods used for communications among devices in other network configurations, with or without scheduling windows, are generally referred to herein as communication windows.

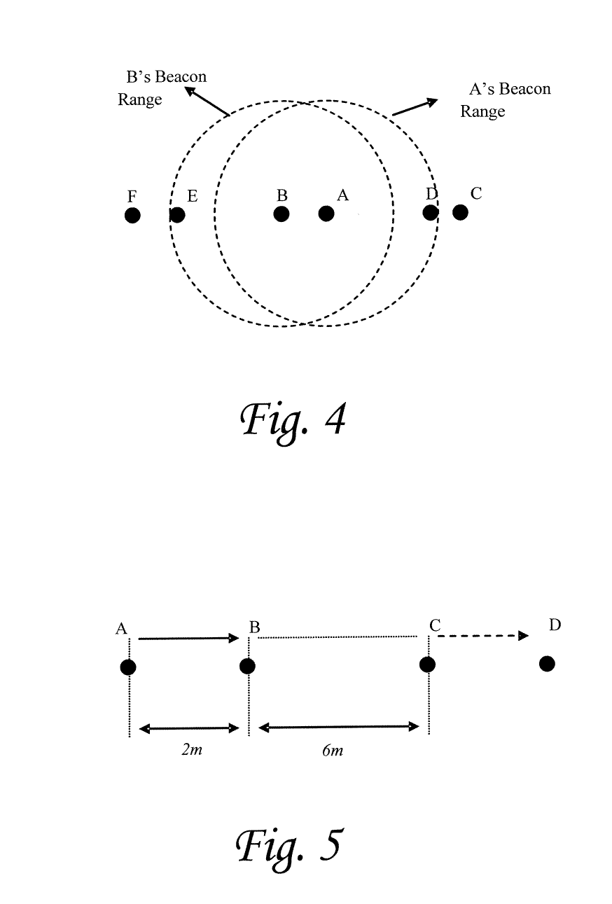

Having thus described an example environment in which the invention can be implemented, various features and embodiments of the invention are now described in further detail. Description may be provided in terms of this example environment for ease of discussion and understanding only. After reading the description herein, it will become apparent to one of ordinary skill in the art that the present invention can be implemented in any of a number of different communication environments (including wired or wireless communication environments, and distributed or non-distributed networks) operating with any of a number of different electronic devices and according to various similar or alternative protocols or specifications.

Where shorter transmission ranges are used between network devices, such as, for example, in a mesh network, interference can be limited. Additionally, with mesh networks having sufficient nodes, simultaneous, spatially separated data flows are possible. However, the current WiMedia MAC protocol does not allow such concurrent access to the medium and it can be overly conservative, leading to an unnecessary reduction in network throughput. FIG. 4 is a diagram illustrating a network configuration that can be used to illustrate an inefficiency associated with the conventional WiMedia MAC protocol. Referring now to FIG. 4, six network devices, A, B, C, D, E and F are illustrated as spatially separated. Assume that device A has a continuous stream of data that it wants to send to device B. According to the WiMedia MAC protocol, device A will include in its beacon a field to reserve a certain set of medium access slots (MASs), say set X, to send its data stream to device B. Now, according to the WiMedia MAC protocol, device A uses its maximum transmission power (TP) to send its beacons to reserve set X. Since device D is in range of device A, when device D receives A's beacon, it refrains from transmitting to device C during the identified set X to avoid corrupting device A's reception of device B's ACK packets. Device D also refrains from receiving from device C to avoid having its reception corrupted by A's data transmission. The inability of device D to transmit while A is transmitting its data packet is the well-known exposed device problem.

Now, further assume that device E may want to transmit to device F. In the above scenario, device E hears device B's beacon and, therefore, refrains from transmitting to device F during the medium access slots identified by B's beacon (for example, set X) to avoid corrupting B's reception of A's data packets. Device E also refrains from receiving from device F to avoid having its reception corrupted by B's ACK transmissions.

However, according to one embodiment of the invention, protocols can be established such that the three transmissions, A-B, C-D, and E-F can proceed simultaneously (for example, using the same set of media access slots). Enabling multiple transmissions to take place within the same neighborhood can lead to an increase in network throughput. Thus, in one embodiment, a network can be implemented such that such transmissions take place whenever possible. In another embodiment, a distributed scheme can be implemented to enable neighboring devices to decide whether or not they can transmit during the same medium access slot using minimal information exchange.

The inventors have determined that root of the problem with the conventional WiMedia MAC process lies in its conservative definition of a collision. For example, if a terminal i is currently receiving a packet from a terminal j, then, as the above example illustrates, all other terminals in i's and j's transmission ranges defer their transmissions to avoid colliding with i's ongoing reception of the data packet and j's subsequent reception of the ACK packet.

FIG. 5 is a diagram illustrating another sample network configuration used to illustrate an example scenario wherein the current WiMedia MAC scheme is overly conservative. Referring now to FIG. 5, four network devices, A, B, C and D are illustrated as spatially separated. Assume for purposes of illustration that devices A and C are concurrently sending data to devices B and D, respectively, using the same maximum power (Pₘₐₓ). Further Assume that device B's target signal-to-noise ratio (SNR_{Target}) is equal to 8 dB, and the path loss attenuation exponent is equal to 3. For this example, thermal noise is ignored. The measured signal-to-noise ratio at device B of the signal received from device A is more than 14 dB while device C is transmitting. Thus, it possible for device B to reliably receive device A's signal (be it data or ACK) while device C is transmitting (because SNR_{measured}>SNR_{Target}). However, as noted above, the conventional WiMAC protocol does not allow for these two transmissions to occur simultaneously, because it requires device C to defer or reschedule its own transmission once it learns about B's reservation (for example, through B's beacon), assuming that the beacon has sufficient range (say, for example, 10 m).

Before describing the invention in further detail, a few assumptions regarding the conventional WiMedia MAC protocol are discussed. In order for the conventional WiMedia MAC protocol to properly function, one assumption that can be made is that the channel gain is stationary for the duration of several superframe transmission periods. This can be assumed because, if the channel gain does not remain stationary for a sufficient period, network performance is not predictable to a certain degree and devices may randomly miss or receive their neighbors' beacons. As a result, network devices may consume unnecessary amounts of time on DRP conflict resolutions. Stationary channel gain is not unrealistic for slow mobility patterns (for example, 1 m/s).

Another assumption that is made is that the gain between two terminals is the same in both directions. This assumption is made because if the gain were different, the conventional reservation protocol would not work properly. The WiMedia MAC specification mentions that “A recipient device may use the Link Feedback IE to suggest the optimal data rate to be used by a source device, for example, to increase throughput and/or to reduce the frame error rate. The data rate in the Link Feedback IE should be interpreted as the maximum data rate that the source device should use for this particular link, for an acceptable frame error rate.” As such, another assumption that can be made is that a device receiver knows in advance what the maximum rate is that the transmitter may use.

In one embodiment of the present invention, it can be further assumed that the PHY is capable of providing an estimate of the average power and the signal-to-noise ratio of a desired received signal. Using these two values, the MAC protocol can compute an estimate of the interference power level at its location.

In one embodiment of the invention, the network uses additional device information to determine when multiple simultaneous transmissions are permissible. Particularly, in one embodiment, the invention uses this additional information to determine whether an actual conflict exists for multiple simultaneous transmissions, and allows multiple simultaneous transmissions to occur where the likelihood of interference is below a predetermined acceptable threshold.

In one embodiment, this can be accomplished by configuring network devices to broadcast some collision avoidance information to neighboring network devices. For example, in one embodiment, a network device can be configured to broadcast collision avoidance information to neighboring devices in its beacon packet, or during another time period. Neighboring devices can use this collision avoidance information along with other information to determine whether concurrent transmissions can occur. For example, in one embodiment, neighboring devices use the channel gain information learned through beacon exchanges to determine the likelihood of interference, and thus to determine when concurrent data transmissions can occur.

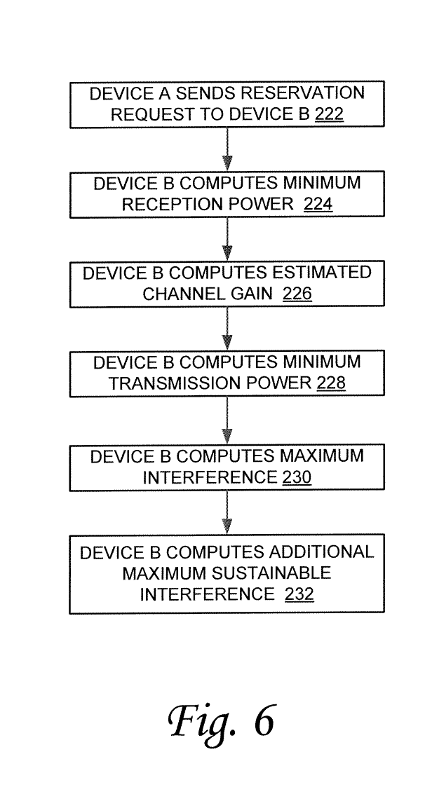

To better illustrate, consider a simple example. FIG. 6 is an operational flow diagram illustrating this simple example with reference to the example configuration illustrated in FIG. 5. For purposes of illustration, let RB be the maximum desired (or supported) data rate at a target device, B. SNR(RB) denotes the corresponding required signal-to-noise ratio for device B. In one embodiment, the signal-to-noise ratio can be estimated at the design phase, and typically depends on the receiver structure (e.g., coding scheme) and the channel model. In one embodiment, a safety margin can be used to account for estimation errors. For example, a safety margin of 3 dB can be factored in to the signal-to-noise ratio budget.

Referring now to FIGS. 5 and 6, In a step 222, device A sends a reservation request to device B. In terms of the example environment, this can be done, for example, during the beacon period. In a step 224, receiving the reservation request from device A, device B computes the minimum reception power it requires for reliable communication. In one embodiment, device B computes the minimum reception power as follows:
P_{rec}(B)=SNR(R_{B})*I_{current}(B), (1)
where I_{current}(B) is the current estimated interference power level at device B (in accordance with the assumptions set forth above).

In a step 226, device B computes the estimated channel gain. In one embodiment, this can be accomplished using the reception signal strength indication (RSSI) of A's beacon. For example, device B can compute the estimated channel gain (G_{AB}) between itself and A defined as:
G_{AB}=RSSI/Pₘₐₓ, (2)
where Pₘₐₓ is the maximum power. In one embodiment, beacons are transmitted at Pₘₐₓ, which can be a pre-determined parameter. Other known power levels can be established and used.

In a step 228, device B computes the minimum transmission power (P-ₜᵣ(AB)) that device A should use to send its packets (data or ACK packets) to device B. In one embodiment, this can be determined based device B's minimum reception power and the estimated channel gain between itself and device A. Thus, using equations (1) and (2), the minimum transmission power that device A should use to send its packets to device B can be computed as:
Pₜᵣ(AB)=P_{rec}(B)/G_{AB} (3)

As would be apparent to one of ordinary skill in the art after reading this description, any extra power (for example, above Pₜᵣ(AB)) would allow device B to sustain additional interference beyond current levels of interference at device B, I_{current}(B).

In a step 230, device B computes the maximum interference that it can sustain when A transmits at Pₘₐₓ. In one embodiment, this is determined as:
Iₘₐₓ(B)=Pₘₐₓ*G_{AB}/SNR(R_{B}) (4)

Using this, in a step 232 device B computes the additional maximum sustainable interference, denoted by P_{MSI}(B), that device B can sustain from new transmissions in its vicinity as:
P_{MSI}(B)=Iₘₐₓ₍B)−I_{current}(B) (5)

Note that if device B is only transmitting during a certain periods or media access slots (e.g., data packets with no-ACK), then P_{MSI}(B) can, in one embodiment, be set to infinity to indicate that device B does not receive during that MAS and that device B's neighbors can use whatever power they wish. Also note that maximum levels can be determined as absolute maximums, or safety margins can be established and included in determining maximums.

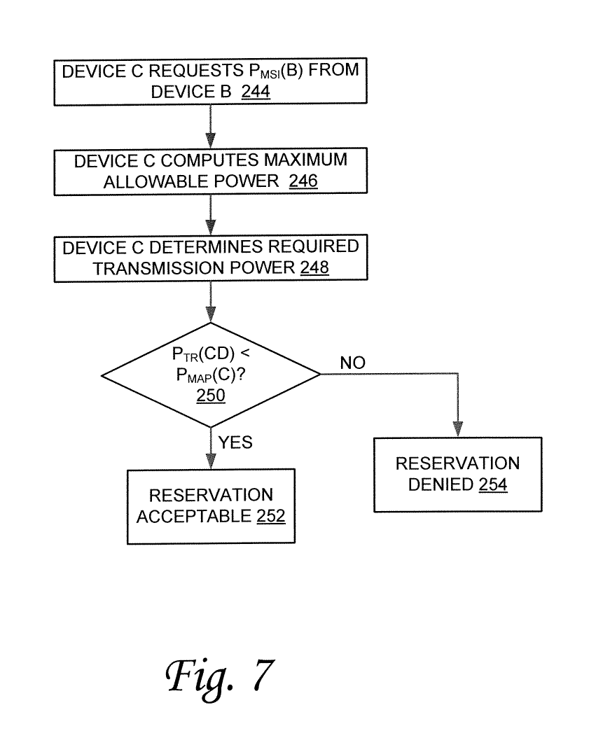

FIG. 7 is a diagram illustrating an example process for determining whether another device (for example, device C of FIG. 5) that wishes to reserve the same slot should be allowed to reserve that slot in accordance with one embodiment of the invention. Referring now to FIG. 7, if device C (see FIG. 5), wishes to reserve the same slot (e.g., MAS) that device B has previously reserved, then in one embodiment, in a step 244 device C includes in its beacon a request for node B to include the value of P_{MSI}(B) in device B's subsequent beacons.

Note that in one embodiment, although this information can consume a minimal amount of bandwidth (for example, perhaps 2 bytes), devices (e.g., device B in the above example) do not need to include this overhead in their beacons all the time. Instead, devices in one embodiment can include this information only when another device requests it. On receiving this information in a step 246, the receiving device (e.g., device C in the above example) can compute the maximum allowable power (P_{MAP}(C)) it can use such that the interference power caused by device C to device B is less than P_{MSI}(B) as follows:
P_{MAP}(C)=P_{MSI}(B)/G_{CB} (6)

Note that G_{CB} is readily available via the reception of B's beacon. In a step 248 device C determines the transmission power, Pₜᵣ(CD), required to send packets to device D (assuming device D has informed C about I_{current}(D)). In one embodiment, device C uses equations (1) to (3) to determine Pₜᵣ(CD).

If Pₜᵣ(CD)<P_{MAP}(C), then the transmission power that C needs to use to transmit packet to D should not cause a collision at device B, and so C can reserve the same MAS that B has previously reserved. This is illustrated by steps 250 and 252. If, on the other hand, Pₜᵣ(CD)>P_{MAP}(C), then the transmission power that compute the maximum allowable power device C needs to use to transmit packet to device D will likely cause a collision at device B and C's request is denied. This is illustrated by steps 250 and 254.

Once device C confirms in its beacon its intention to share the MAS with device B, in one embodiment, one or more of devices A and B can increase their power for example, to Pₘₐₓ to reduce the likelihood of interference from device C. As such, device B can be configured to increase to maximum power Pₘₐₓ and to inform device A to start using Pₘₐₓ for all subsequent packets exchanged with device A, so that device B can sustain the interference from device C.

The above procedure can be implemented so that device C's transmission does not disturb device B's reception (be it ACK or data). However, in one embodiment, there is one more condition that device C can examine before it decides whether to share the same MAS with device B. This condition is that device B's transmission does not disturb possible reception at C (e.g., ACK reception). This is accomplished using a similar method to the one described above. Basically, device C is configured to make sure that the interference from B (i.e., G_{BC}*Pₘₐₓ) does not exceed P_{MSI}(C).

As the above example illustrates, in one embodiment, where a device C wishes to share a time slot with device B, device C checks the effect of device C's transmission on the receptions in device C's neighborhood and the effect of device C's neighbors' transmissions on device C's reception. In one embodiment, device C can be required to fulfill two feasibility conditions: (1) Device C's transmission (data or ACK) should not disturb already scheduled receptions in C's vicinity; and (2) The additional interference due to already scheduled transmissions is not sufficient to interfere with the ability of device C to receive packets.

It will be apparent to one of ordinary skill in the art after reading this that the same conditions on device C should also be met by the target device with which device C wishes to communicate. As such, if device D (device C's target) receives device B's beacons, then in one embodiment, device D can be configured to perform the same computations as described above for device C before accepting a reservation from device C.

In one embodiment, network devices continue to advertise their maximum sustainable interference (e.g., device B keeps advertising PMSI(B) in its subsequent beacons). If channel conditions change, PMSI(B) and PMAP(C) will also likely change. Thus, in one embodiment, device C (and device D) are configured to monitor the two feasibility conditions discussed above. If any of these two conditions is not fulfilled in a certain superframe, then the link between devices C and D can be aborted for that superframe. Such devices that share MASs are taking the risk of dropping their reservation at any time, but are also taking advantage of using shared MAS for certain duration of time; something that would not have been allowed by the current WiMedia MAC protocol.

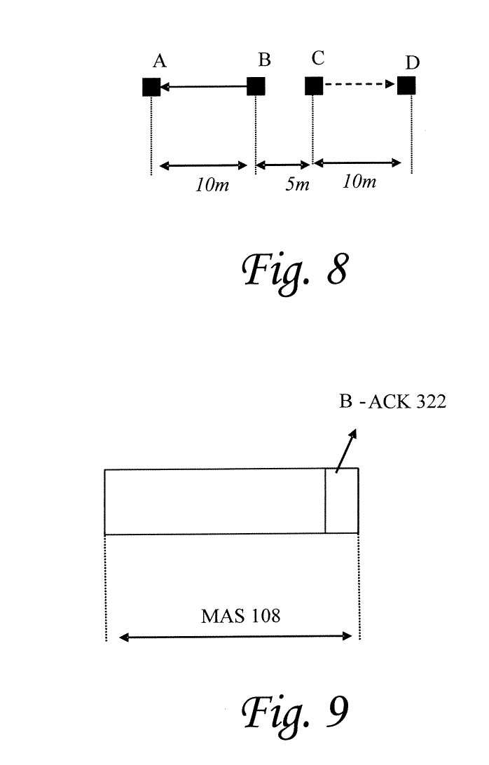

In one embodiment, neighboring device communications can be protected during an entire frame or MAS duration. However, in another embodiment, finer granularity determinations can be made. For example, in one embodiment, requirements can be relaxed where neighboring devices are configured to synchronize their transmission and reception roles. To illustrate, consider FIG. 8, which is a diagram illustrating an example scenario where device B is transmitting data to device A, while device C wishes to send data to device D.

In the illustrated example, assume that device C cannot hear device A's beacon, and device D cannot hear device B's beacon. If device C is configured to must protect device B's ACK reception during the entire period (e.g., during the entire MAS), then device C and device A cannot transmit at the same time (their data and ACK, respectively) because device C's transmission is higher than device B's maximum sustainable interference.

However, in one embodiment, device B and device C are configured to synchronize their reception and transmissions time, (for example, device C transmits when device B is transmitting and device C receives when device B is receiving), then both device C and device B can use the same time slot. However, the conventional WiMedia MAC precludes the possibility of parallel communication by two neighboring nodes that are either both owners or both targets. The key reason for this restrictive behavior is that a device reverts between a transmitter and receiver roles multiple times during a MAS without a precise, explicit knowledge of when these role reversals take place.

Thus, in one embodiment, devices can be configured to send the block ACK (B-ACK 322) at the end of the period (e.g., at the end of media access slot 108) as illustrated in FIG. 9. As such, a predetermined percentage of the MAS 108 (for example, 10%) is dedicated for sending the B-ACK 322. This can be implemented in one embodiment to avoid reverting between transmitter and receiver roles multiple times during a MAS, and thus allow device C and device B to use the same MAS regardless of their TPs.

In one embodiment noted above, device C is able to use the same MAS as device B only if the interference from device B is not high enough to disturb device C's reception. In some cases, this condition would be satisfied if device B is using a power less than Pₘₐₓ. If the power used to transmit a data packet to a terminal, i, is just enough to overcome the current interference at i, then, in one embodiment, none of i's neighbors should be allowed to start new transmissions during i's reception. Such a silencing of neighboring terminals can negatively impact the aggregate throughput. On the other hand, if the TP is too high, it may induce high interference on other terminals in the vicinity of the transmitter, preventing them from receiving. Therefore, in one embodiment, load control can be implemented to allow a prospective device to determine the appropriate TP for its upcoming reception and transmission.

The load factor at terminal i, denoted by LF(i), is a measure of the activity in terminal i's neighborhood. Formally, it can be defined as LF(i)=I(B)/Pₜₕₑᵣₘₐₗ.

With load planning, devices can be configured, for example, to impose a maximum load factor (MLF) that terminals, in one embodiment, are not allowed to exceed. This maximum load factor can be set at the design phase to reflect several goals, including throughput, network lifetime, etc. If LF(i)>MLF, then the interference at device i is high and this link should not be activated. As such, this design can be implemented to prevent transmissions from taking place over links that perceive high interference.

If LF(i)<MLF, then device i can use the MLF to decide P_{rec} in equation (1) as follows:
P_{rec}(B)=SNR(R_{B})*MFL*Pₜₕₑᵣₘₐₗ (7)

In summary, the goal is to reduce the power that device B is using for transmission (below Pₘₐₓ) so that device C's reception is not corrupted by device B's transmission. This, in some cases, may allow for concurrent transmissions that may not have been allowed if B is using Pₘₐₓ.

As used herein, the term “module” is used to describe a given unit of functionality that can be performed in accordance with one or more embodiments of the present invention. As used herein, a module can be implemented utilizing any form of hardware, software, or a combination thereof. In implementation, the various modules described herein can be implemented as discrete modules or the functions and features described can be shared in part or in total among one or more modules. In other words, as would be apparent to one of ordinary skill in the art after reading this description, the various features and functionality described herein may be implemented in any given application can be implemented in one or more separate or shared modules in various combinations and permutations. The term tool can be used to refer to any apparatus configured to perform a recited function. Tools can include a collection of one or more modules and can also be comprised of hardware, software or a combination thereof. Thus, for example, a tool can be a collection of software modules, hardware modules, software/hardware modules or any combination or permutation thereof. As another example, a tool can be a computing device or other appliance on which software runs or in which hardware is implemented.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of allocating simultaneous communications among a plurality of network devices, comprising:
determining a maximum power level that a first device can use in transmitting information to a second device during a given time period without causing a predetermined level of interference to a third device;
determining a minimum amount of power required for the first device to effectively transmit information to the second device; and
determining whether the minimum power required is less than the maximum power level, and if so, allowing the first device to transmit information to the second device during the given time period.

2. The method of claim 1, further comprising the step of, prohibiting the first device from transmitting information to the second device during the given time period if the minimum power required is more than the maximum power level.

3. The method of claim 1, wherein the step of determining a maximum power level, comprises the steps of determining a maximum interference a third device can sustain and determining a power level for the first device that would invoke the maximum interference on the third device.

4. The method of claim 1, wherein the steps of determining are all performed by the first network device to determine whether it can transmit data during the given time period.

5. The method of claim 1, wherein the maximum allowable power is computed as P_{MAP}=P_{MSI}/G, where P_{MAP} is the maximum allowable power of the first device, P_{MSI} is the interference caused to the third device, and G is the channel gain between the first device and the third device.

6. The method of claim 1, further comprising the steps of the third device computing its maximum acceptable interference level for the given time period, and the third device transmitting a value representing the maximum acceptable interference level for the given time period to the first device.

7. The method of claim 1, wherein the maximum acceptable interference level comprises the maximum additional interference that the third device can sustain from new transmissions in its vicinity.

8. A network device configured to determine whether it can conduct simultaneous communications with another network device in a given time slot, comprising:
first control logic configured to determine a maximum power level that a first device can use in transmitting information to a second device during a given time period without causing a predetermined level of interference to a third device;
second control logic configured to determine a minimum amount of power required for the first device to effectively transmit information to the second device; and
third control logic configured to determine whether the minimum power required is less than the maximum power level, and if so, allowing the first device to transmit information to the second device during the given time period.

9. The network device of claim 8, wherein the third control logic is configured to prohibit the first device from transmitting information to the second device during the given time period if the minimum power required is more than the maximum power level.

10. The network device of claim 8, wherein the first control logic is configured to determine a maximum interference a third device can sustain and determining a power level for the first device that would invoke the maximum interference on the third device.

11. The network device of claim 8, wherein the maximum allowable power is computed as P_{MAP}=P_{MSI}/G, where P_{MAP} is the maximum allowable power of the first device, P_{MSI} is the interference caused to the third device, and G is the channel gain between the first device and the third device.

12. The network device of claim 8, further comprising fourth control logic configured to compute the maximum acceptable interference level the network device can sustain for a given time period.

13. The network device of claim 1, wherein the maximum acceptable interference level comprises the maximum additional interference that the third device can sustain from new transmissions in its vicinity.

14. A computer program product comprising a computer useable medium having computer program logic embodied therein for enabling a controller in a network device to determine whether the network device can transmit data to a second network device in a given time period, said computer program logic comprising:
first computer readable program code for enabling the controller to determine a maximum power level that a first device can use in transmitting information to a second device during a given time period without causing a predetermined level of interference to a third device;
second computer readable program code for enabling the controller to determine a minimum amount of power required for the first device to effectively transmit information to the second device; and
third computer readable program code for enabling the controller to determine whether the minimum power required is less than the maximum power level, and if so, allowing the first device to transmit information to the second device during the given time period.

15. The computer program product device of claim 14, wherein the third computer readable program code causes the controller to prohibit the first device from transmitting information to the second device during the given time period if the minimum power required is more than the maximum power level.

16. The computer program product device of claim 14, wherein the first computer readable program code causes the controller to determine a maximum interference a third device can sustain and determining a power level for the first device that would invoke the maximum interference on the third device.

17. The computer program product device of claim 14, wherein the maximum allowable power is computed as P_{MAP}=P_{MSI}/G, where P_{MAP} is the maximum allowable power of the first device, PMsI is the interference caused to the third device, and G is the channel gain between the first device and the third device.

18. The computer program product device of claim 14, further comprising fourth computer readable program code for enabling the controller to compute the maximum acceptable interference level the network device can sustain for a given time period.

19. The network device of claim 18, wherein the maximum acceptable interference level comprises the maximum additional interference that the third device can sustain from new transmissions in its vicinity.
